(19) United States
(12) Patent Application Publication
(10) Pub. No.: US 2010/0057857 A1
(43) Pub. Date: Mar. 4, 2010

(54) CHAT MATCHING

(76) Inventor: Christopher T. Szeto, San Jose, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/199,553

(22) Filed: Aug. 27, 2008

(51) Int. Cl. G06F 15/16

(52) U.S. Cl. 709/206

(57) ABSTRACT

Techniques for communicating via an instant messaging service are provided. In one technique, a user of an instant messaging application selects a particular status that indicates that the user wants to chat. In response to the selection, the instant messaging application displays a list of references to other users that have also selected the particular status. In another technique, the user selects a topic about which the user wishes to discuss. References to other users that have selected the same or similar topic are displayed to the user.

### FIELD OF THE INVENTION

The present invention relates to instant messaging and, more specifically, to discovering users with which to communicate.

### BACKGROUND

Instant communication, like email, is a popular means of communication over the Internet. With instant (or real-time) communication, a particular user can provide information to one or more users as soon as the particular user hits “Enter” or selects a “Send” button. A recipient of an instant communication does not have to wait for an indication of the instant communication to show up in the recipient's email box. Instead, an instant communication from a sender is instantly displayed on the recipient's computer screen.

Another difference between instant communication and email communication is who is allowed to send an instant communication to a user. In email communication, anyone who has access to a user's email address can send an email to that user. In contrast, with instant communication, a first user's possession of a second user's instant communication identifier does not automatically grant the first user permission to send an instant communication to the second user. Instead, if a first user is not a contact of a second user and the first user has the second user's instant communication identifier, then the first user must first send an invitation to the second user to add the second user to the contact list of the first user. If the second user refuses, then the first user cannot send an instant communication to the second user.

However, like email, the type of data sent in instant communications include, without limitation, text, graphics, audio, and video.

Instant messaging services provide users with the ability to communicate instantly (i.e., real-time) with other users. When a user uses an instant messaging service for the first time, that user is typically not immediately associated with any contacts. One way for a particular user to add contacts is through the user's email service. Some instant messaging services allow a user to send, to the contacts in the user's email service, an email that allows the contacts to be added to the particular user's instant messaging service. However, this process typically takes a significant amount of time and, usually, not every contact replies to such an email. Also, some contacts may employ a different instant messaging service than the service used by the particular user. Such contacts may not want to (a) initiate and learn a different instant messaging service and (b) maintain a separate instant messaging account just for the particular user.

Even if a user has many contacts in his/her instant messaging service contact list, it is not guaranteed that the user's contacts will be online at the same time, especially in countries where many users do not own their own computers. The only access to the Internet for such users is through Internet cafes. Thus, it may be unlikely that a user will have a friend to chat with online when the user visits an Internet cafe.

The instant messaging service provided by ICQ™ included a mechanism that allowed a user to set his/her status to a particular status that indicated that the user wanted to chat. The status of the user was viewable by the user's contacts that were also logged into the same service at the same time. However, even if a user has many contacts, there is no guarantee that any of the contacts want to chat when the user is logged in.

One way for a particular user to communicate with previously unknown users (and perhaps eventually add new contacts to the particular user's contact list) is to “enter” chatrooms and begin chatting with users through that service. Although chatrooms may be considered a type of instant messaging service, chatrooms are herein not included in the definition of instant messaging services. A significant difference between chatrooms and instant messaging services (such as Yahoo! Instant Messenger™, MSN Messenger™, and Skype™) is that in order to communicate through an instant messaging service, a first user must consent to be added to a second user's contact list before the second user can send a message to the first user. This requires the second user to know the first user's unique identifier (or user name), not just the first user's display name, which may not be unique relative to other users of the same instant messaging service. Two users are said to be contacts of each other (or “buddies”), with respect to an instant messaging service, if the two users have formally established a relationship through the instant messaging service.

In contrast, any user may enter a chatroom and begin communicating with all users in the chatroom simultaneously or with users in the chat room individually, without requiring any of the users to formally establish a relationship before communicating. If a user submits a comment or question to a chatroom, then all other users that are part of that chatroom will see that submission. Chatrooms typically have a list of users that are currently “in” the chatroom. A chatroom user may select one of the users in the list and begin a separate conversion with that user without all the users in the chatroom being able to view that conversion. Also, chatrooms typically are associated with topics. Thus, users who enter a chatroom are expected to discuss the topic associated with the chatroom.

If two users have an interesting discussion and would like to further chat one-on-one in the future, then the two users may share their respective unique identifiers (e.g., user names) associated with their respective instant messaging services. The two users then follow the protocol (associated with their instant messaging service) for adding each other to their respective contact lists.

Although chatrooms are useful in matching up users with similar interests, many problems associated with chatrooms have surfaced as the Internet has become increasingly popular. One problem with chatrooms is that they may be spammed with unseemly messages. A single user may send an inappropriate message (e.g., text, audio, or video) that is viewed by all users in the chatroom.

Another problem with chatrooms that they typically comprise senseless chatter between two or more users. Users are not required to communicate about the topic(s) associated with the chatroom; thus, a current discussion in a chatroom may be way off topic.

Still another problem with chatrooms is that many are probed by bots. A chatroom bot is a computer program that collects information about users in the chatroom, such as users' identifiers, messages that each user has submitted, which users are communicating with each other individually. Unbeknownst to a chatroom user, information about the user may be shared with others unaffiliated with the user. Chatroom bots may even ban (or prevent) certain users from entering a chatroom.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A depicts an example instant messaging application;

FIG. 1B depicts a drop down menu that lists various statuses from which a user may select, according to an embodiment of the invention;

FIG. 1C depicts an example instant messaging application displaying a list of ‘Chat with Me’ users in response to a user selecting the ‘Chat with Me’ status, according to an embodiment of the invention;

FIG. 1D depicts an example instant messaging application filtering ‘Chat with Me’ users based on a customized topic selected by a particular user, according to an embodiment of the invention; and

FIG. 2 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for allowing a user of a particular status to communicate with other users of the same, or similar, status. The particular status is referred to herein as a ‘Chat with Me’ status. When a particular user of an instant messaging application selects the ‘Chat with Me’ status, references to other users of the same status are provided to the particular user, even though that particular user has not established a formal relationship with any of those users.

Embodiments of the invention are not limited to how an instant messaging application is implemented. For example, an instant messaging application may be client-based or web-based. A client-based application executes on a user's computer. In contrast, a web-based application is accessed via a web browser executing on a user's computer. The web browser accesses a server that provides the web-based instant messaging application. With the web browser, a user can view his/her contacts and establish a communication session with one or more contacts. Web-based instant messaging applications are popular for users who access the World Wide Web primarily from computers that they do not own, such as in Internet cafes.

### Status

A user of an instant messaging application may be associated with multiple statuses. The “status of a user” is typically an indication of a user's availability. A user's status is displayed to each of the user's contacts that are also logged into their respective instant messaging application. Non-limiting examples of possible statuses includes ‘Available’, ‘Busy’, ‘Stepped Out’, ‘On the phone’, ‘Not at my desk’, or ‘Logged Off’.

A status may be pre-defined in an instant messaging application, such as the above example statuses. In other words, an instant messaging application “out of the box” provides a set of possible statuses from which a user may select. Alternatively, a status may be defined by a user. For example, a user may create a new status entitled ‘At client meeting’. Alternatively still, a user may select a pre-defined status and then modify that status according to the user's particular situation. For example, a user may select the pre-defined ‘Stepped Out’ status and then add the phrase “- will return at 2 pm”.

A user is not limited to being associated with one status at a time. A user may be associated with multiple statuses simultaneously. For example, a user may select the statuses ‘Busy’ and ‘On the phone’ and be associated with those statuses simultaneously.

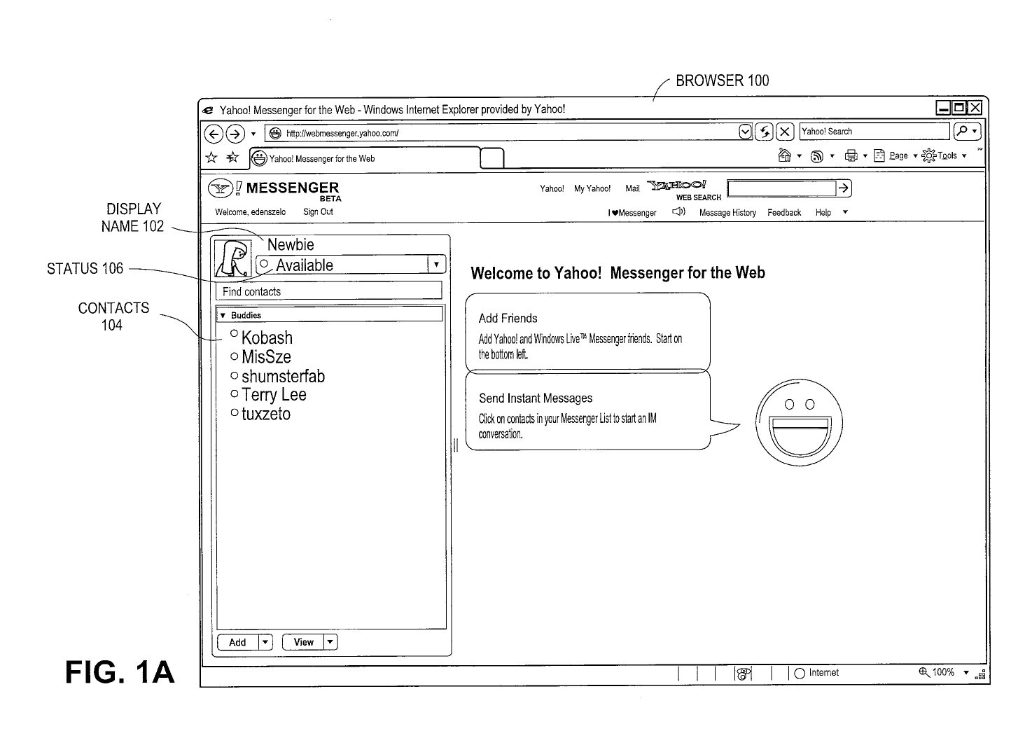

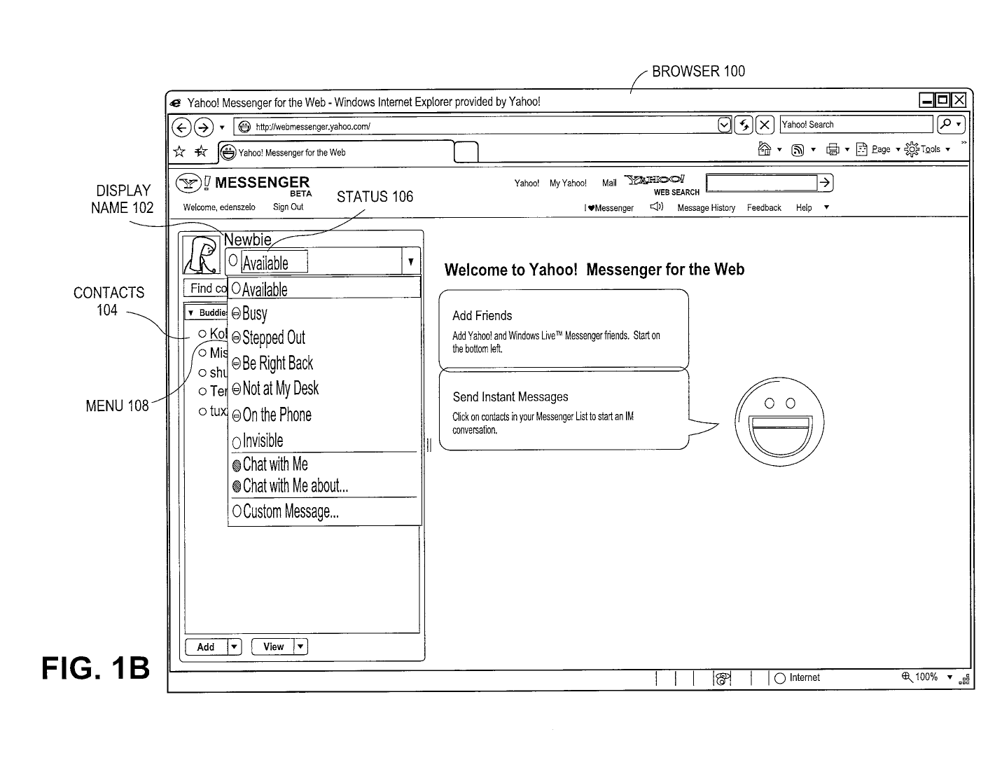

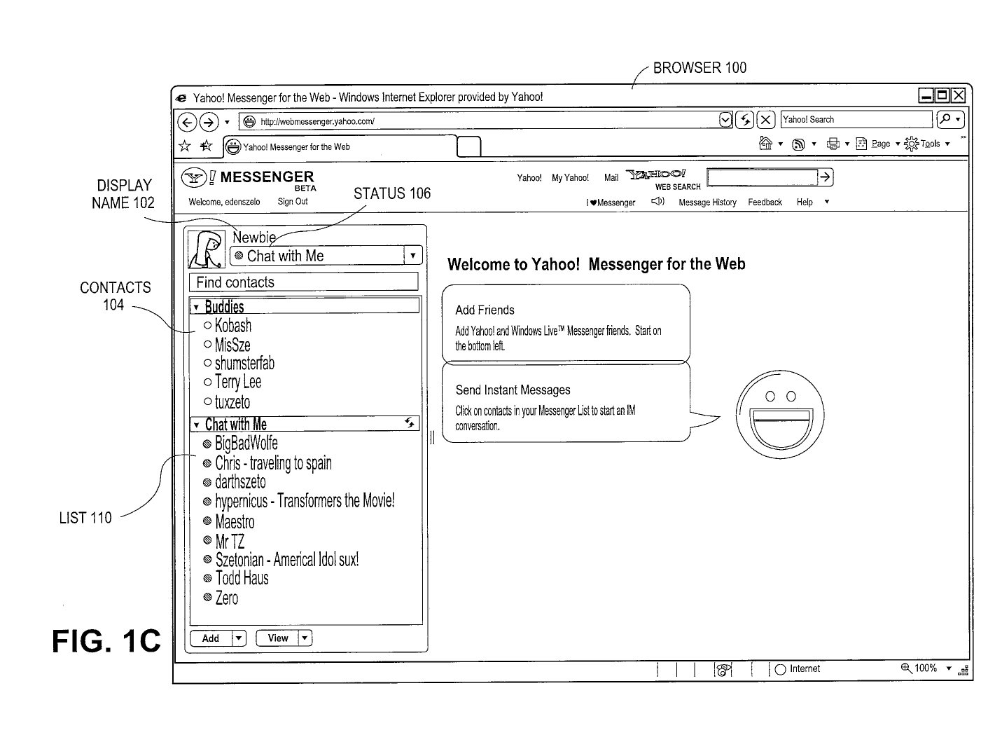

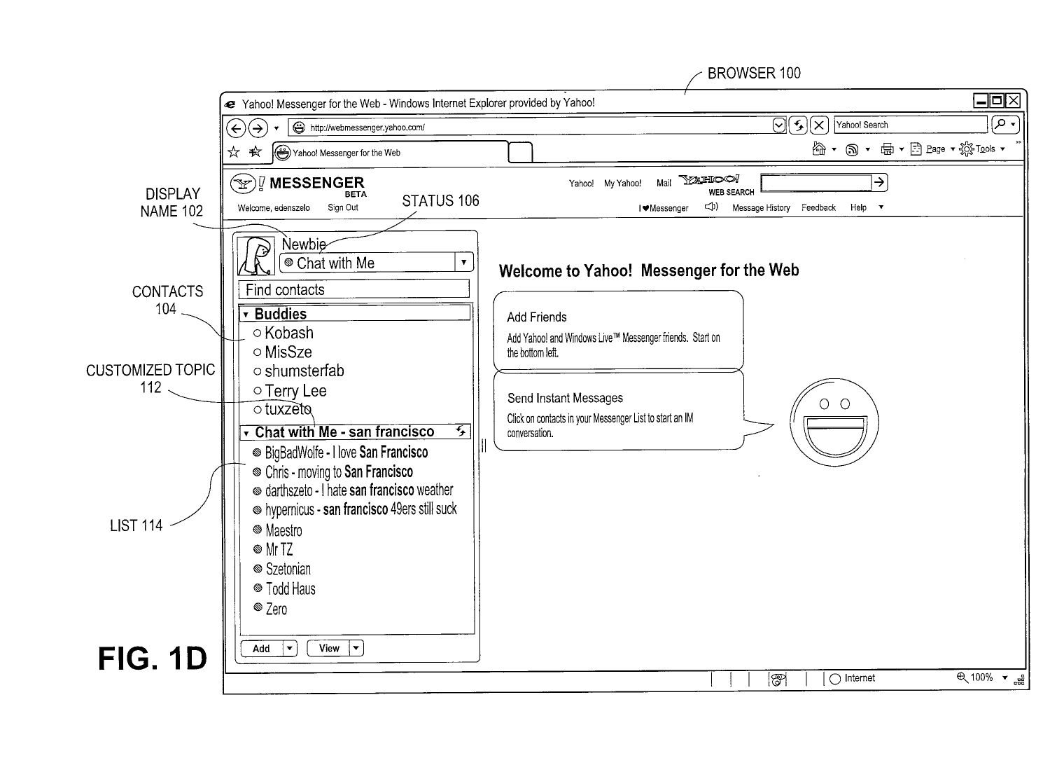

FIG. 1A depicts an example instant messaging application viewable via browser 100, according to an embodiment of the invention. In this example, the instant messaging application is web-based; however, as explained previously, embodiments of the invention are also applicable to client-based instant messaging applications. Display name 102 is the display name of the user (i.e., “Newbie”) of the depicted instance of the instant messaging application (referred to hereinafter simply as the “instant messaging application.” Other users may be using, simultaneously with respect to user Newbie, other instances of the instant messaging application). As depicted in FIG. 1A, user Newbie is currently associated with contacts 104, referred to as “buddies”: Kobash, MisSze, shumsterfab, Terry Lee, and tuxzeto. User Newbie is said to have five buddies. If user Newbie had just begun using this particular instant messaging service, then user Newbie would most likely not have any buddies initially.

Each user of the instant messaging application is associated with a status 106. Typically, when a user logs in to an instant messaging application, a default status of that user is ‘Available’. According to FIG. 1A, user Newbie is said to be ‘Available’.

### ‘Chat with Me ’ Status

According to an embodiment of the invention, a particular user may select a status that indicates to other users that the particular user desires to “chat” or communicate with another user. Such a status is referred to herein as the ‘Chat with Me’ status. A user that has selected the ‘Chat with Me’ status is referred to herein as a “‘Chat with Me’ user.” The status ‘Available’ only indicates that the corresponding user is available to chat, but not necessarily that the user desires to chat at that instant. The ‘Chat with Me’ status, on the other hand, indicates not only that a ‘Chat with Me’ user is available to chat, but that the ‘Chat with Me’ user would also like to chat while the user is associated with that status.

FIG. 1B depicts a drop down menu 108 that lists various statuses from which user Newbie may select. Menu 108 includes statuses ‘Available’, ‘Busy’, ‘Stepped Out’, ‘Be Right Back’, ‘Not at My Desk’, ‘On the Phone’, and ‘Invisible’. Menu 108 also includes statuses ‘Chat with Me’ and ‘Chat with Me about . . . ’. Additionally, drop down menu 108 includes an option for user Newbie to customize a status via the ‘Customize Message . . . ’ option.

### Displaying ‘Chat with Me’ Users

In an embodiment of the invention, in response to a user selecting the ‘Chat with Me’ status, the user's instant messaging application displays, to the user, a list of references of other ‘Chat with Me’ users. Although not strictly accurate, displaying a list of references of ‘Chat with Me’ users is referred to herein as “displaying ‘Chat with Me’ users.”

For example, FIG. 1C depicts browser 100 displaying a list 100 of ‘Chat With Me’ users in response to user Newbie selecting the ‘Chat with Me’ status. User Newbie is not required to perform any other action for list 110 to be displayed other than selecting the ‘Chat with Me’ status. List 110 comprises nine ‘Chat with Me’ users: BigBadWolfe, Chris, darthszeto, hypernicus, Maestro, Mr TZ, Szetonian, Todd Haus, Zero.

In a related embodiment, ‘Chat with Me’ users are displayed to a particular user that has not selected the ‘Chat with Me’ status, or rather selected a variation of the ‘Chat with Me’ status. Such a user may select an option that causes the user's instant messaging application to display ‘Chat with Me’ users without the user being viewed by others as a ‘Chat with Me’ user. For example, a user may want to be seen as ‘Busy’ to the user's contacts but desire to chat with a ‘Chat with Me’ user that was previously unknown to that user.

As depicted in FIG. 1C, instead of displaying a ‘Chat with Me’ user's unique identifier to another user, a display name of the ‘Chat with Me’ user is displayed to the other user, which display name is not necessarily unique. For example, ‘Chat with Me’ user BigBadWolfe in list 110 is displayed to user Newbie. After user BigBadWolfe is no longer displayed (e.g., when user BigBadWolfe logs out of his/her instant messaging application), user Newbie is not able to identify and communicate with user BigBadWolfe, unless user BigBadWolfe provided his/her instant messaging identifier to user Newbie. Therefore, two ‘Chat with Me’ users may communicate with each other without being on each other's respective contact list or knowing each other's unique instant messaging identifier.

Also, even though a first ‘Chat with Me’ user can see a second ‘Chat with Me’ user, the second user does not appear on the first user's contact list without the second user's permission. This mechanism for displaying names that are not the actual (or “real”) identifiers of users hides the true identity of the users. Thus, a ‘Chat with Me’ user is not required to forfeit his/her identity simply by being willing to communicate with (potentially) random users (i.e., by selecting the ‘Chat with Me’ status).

### Techniques for Selecting ‘Chat with Me’ Users to Display

Because it is likely that thousands or tens of thousands of users may be ‘Chat with Me’ users at any given time, various techniques may be used to select which ‘Chat with Me’ users will be displayed to a particular ‘Chat with Me’ user. In one embodiment, only a subset of all ‘Chat with Me’ users (e.g., nine users in the example of FIG. 1C) are displayed at a given time to a ‘Chat with Me’ user. According to one technique, ‘Chat with Me’ users are selected at random.

However, a purpose in selecting ‘Chat with Me’ users to display to a particular user may be to identify ‘Chat with Me’ users that are most likely to have common interests with the particular user. Therefore, in one technique, at least the contacts of a particular user that are ‘Chat with Me’ users are indicated as such. In a related technique, ‘Chat with Me’ users that are in a particular user's social network (such as Yahoo! 360™) are displayed to the particular user. Non-limiting examples of other social networks include MySpace™, Facebook™, and LinkIn™. Additionally, the contacts in a user's email service may be considered part of the user's social network.

In another technique, a profile of a ‘Chat with Me’ user is used to select other ‘Chat with Me’ users to display. A user's profile is associated with the user's instant messaging application. A user's profile may indicate many different types of information about the user, such as gender, age, residence, occupation, nationality, languages spoken, and interests. For example, if the profile of a user indicates that the user is a 25 year old male from Germany, then other ‘Chat with Me’ users that are males from Germany between 21-30 years of age may be more likely to be selected and displayed to the particular user.

Some profile information is more useful than other profile information in selecting ‘Chat with Me’ users to display. For example, a higher weighting may be given to common interests and nationality among ‘Chat with Me’ users than to age or gender of the ‘Chat with Me’ users. As another example, if the languages spoken by one ‘Chat with Me’ user does not include any of the languages spoken by another ‘Chat with Me’ user, then it is very likely that neither user will be displayed to the other user.

In another technique, a web history of a ‘Chat with Me’ user is used to select other ‘Chat with Me’ users to display. Web history of a user may include any type of web-related history associated with the user. Non-limiting examples of web history may include websites and/or webpages that a user has visited, search queries that the user has submitted using an Internet search engine (e.g., the search engine provided by Yahoo!), and social network(s) to which the user belongs.

In a related technique, a combination of the above techniques is used to select ‘Chat with Me’ users to display. For example, each ‘Chat with Me’ user that is the contact list of a first ‘Chat with Me’ users is displayed to the first user. Additionally, four ‘Chat with Me’ users that are in the first user's social network are displayed to the first user. Lastly, the web history of the first user is compared to profile information of a plurality of ‘Chat with Me’ users. Six users of the plurality are displayed to the first user.

A ‘Chat with Me’ user selection process may be performed by a central server (or servers) that is communicatively coupled to multiple instant messaging applications. For example, upon logging in, a user's client-based instant messaging application sends a notification to the central server that indicates that the user is logged in. The central server sends a notification to each of the user's contacts to update their respective statuses associated with the user.

When a particular user becomes a ‘Chat with Me’ user, the central server is notified. The central server knows about each user that is currently a ‘Chat with Me’ user. The central server selects from this pool of ‘Chat with Me’ users which users to display to the particular user.

### Customized Topic

In an embodiment, a ‘Chat with Me’ user may provide, via an instant messaging application, input that the instant messaging application associates with the ‘Chat with Me’ user. The input indicates a topic about which the ‘Chat with Me’ user would like to chat. That topic may be displayed, along with an identity (e.g., display name or user name) of the ‘Chat with Me’ user, to another ‘Chat with Me’ user. The other ‘Chat with Me’ user may use the displayed topic in determining whether to select the associated ‘Chat with Me’ user.

For example, a first user selects the ‘Chat with Me’ status and specifies “places to eat in San Francisco” as a topic. A second user selects the ‘Chat with Me’ status. The second user's instant messaging application displays the first user and the first user's topic. If the second user is interested in discussing various restaurants in San Francisco, then the second user may select the first user, which causes a window to be displayed, through which the second user may begin communicating with the first user.

### Selecting ‘Chat with Me’ Users to Display Based on Customized Topic

In an embodiment, one or more topics associated with one or more ‘Chat with Me’ users are analyzed to select which ‘Chat with Me’ users are displayed to a particular user. In one topic analyzation technique, the topics of ‘Chat with Me’ users may be compared to the topic of a particular user.

For example, FIG. 1D depicts browser 100 after ‘Chat with Me’ users have been filtered based on a customized topic 112 selected by a particular user, according to an embodiment of the invention. In this example, browser 100 displays a list 114 of ‘Chat with Me’ users 114, at least some of which are associated with similar customized topics as the topic selected by user Newbie.

Any technique, such as substring matching, may be used to compare two customized topics. Embodiments of the invention are not limited to any particular comparison technique.

In a related embodiment, an instant messaging application may provide one or more pre-defined topics from which a user may choose. Non-limiting examples of pre-defined topics include general topics such as sports, politics, food, and travel or more specific topics such as a particular professional or college sports team, a particular presidential candidate, and a particular chain restaurant.

Although the last five ‘Chat with Me’ users in list 114 do not have a customized topic, much less a similar topic as user Newbie, information about those five ‘Chat with Me’ users may indicate that they may have something to chat about with user Newbie. Therefore, in another topic analyzation technique, information about ‘Chat with Me’ users may be compared to the topic of the particular user. For example, profile information of ‘Chat with Me’ user Maestro may indicate that user Maestro works in San Francisco. As another example, search history for ‘Chat with Me’ user Mr TZ may indicate that user Mr TZ has frequently issued web-based queries that included the terms ‘San Francisco’.

In a similar topic analyzation technique, the customized topics of ‘Chat with Me’ users may be compared to information about a particular user (e.g., user Newbie). This technique may be used regardless of whether the particular user has selected a customized topic. For example, even if user Newbie did not select a customized topic, a ‘Chat with Me’ user that has selected “San Francisco 49ers” as a customized topic may be displayed due, at least in part, to the fact that profile information about user Newbie indicates that user Newbie is interested in the 49ers NFL football team. This is an example of a serendipitous discovery where one user did not initially know what to chat about, but upon the viewing of a customized topic of another user, decides that he/she also wants to discuss that topic.

### Becoming “Friends”

After communicating, two ‘Chat with Me’ users may decide to become “friends”. Therefore, in an embodiment, an instant messaging application provides an add mechanism for a first ‘Chat with Me’ user (or “first user”) to add a second ‘Chat with Me’ user (or “second user”) to the first user's contact (or Buddy) list. The add mechanism may be, e.g., a button that, when selected by the first user, causes a message to be sent to the second user. If the second user is so inclined, he/she may accept the invitation, in the message, to be added to the first user's contact list. If the second user accepts the invitation, then the first user is also added to the second user's contact list.

In an embodiment, if a first ‘Chat with Me’ user sends an invite message to a second ‘Chat with Me’ user to add the second user to the first user's contact list, then the first user's user name is not displayed to the second user. Thus, the “true” identity of the first user is not revealed to the second user if the second user does not want to add the first user to the second user's contact list.

### Refresh

A particular user may decide not to chat with any of the displayed ‘Chat with Me’ users. For example, the particular user may view the profile information of each displayed ‘Chat with Me’ user by, e.g., selecting each display name or simply “mousing” over each display name. After viewing the profile information, the particular user may determine that none of the displayed ‘Chat with Me’ users appears interesting to chat with.

Therefore, in an embodiment, an instant messaging application provides a refresh option (e.g., an interface button) that, when selected by a user, causes a new set of ‘Chat with Me’ users to be displayed to the user. The same mechanism for selecting ‘Chat with Me’ users, as described previously, may be used, except that none of the ‘Chat with Me’ users that was displayed before the selection of the refresh option is displayed again in response to that selection of the refresh option. In the future, however, one of the “uninteresting” ‘Chat with Me’ users may be selected and displayed again to the user.

### Benefits

A benefit of embodiments of the invention is that features of chatrooms may be combined with instant messaging without much of the disadvantages of chatrooms. For example, a user may discover many users who are willing to chat about a particular topic without the fear of mass spamming or intrusive bots. Not only are embodiments of the invention useful for new users who are not associated with any contacts, even “old” users who have many contacts may chat with an unknown user about any topic of interest or no topic at all.

### Hardware Overview

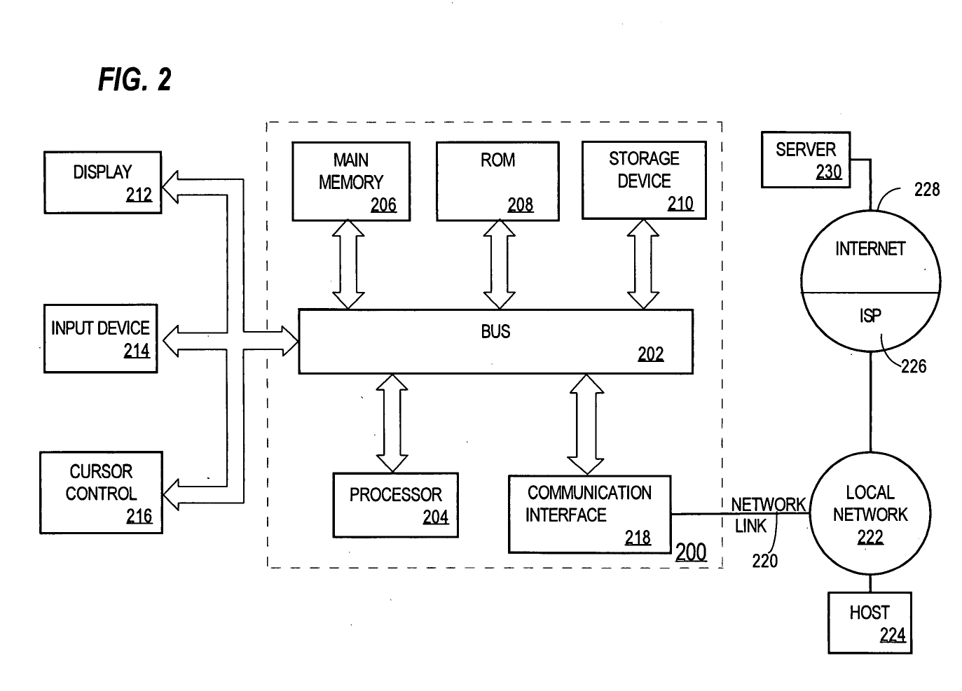

FIG. 2 is a block diagram that illustrates a computer system 200 upon which an embodiment of the invention may be implemented. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variables or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, including alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

The invention is related to the use of computer system 200 for implementing the techniques described herein. According to one embodiment of the invention, those techniques are performed by computer system 200 in response to processor 204 executing one or more sequences of one or more instructions contained in main memory 206. Such instructions may be read into main memory 206 from another machine-readable medium, such as storage device 210. Execution of the sequences of instructions contained in main memory 206 causes processor 204 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 200, various machine-readable media are involved, for example, in providing instructions to processor 204 for execution. Such a medium may take many forms, including but not limited to storage media and transmission media. Storage media includes both non-volatile media and volatile media. Non-volatile media includes, for example, optical or magnetic disks, such as storage device 210. Volatile media includes dynamic memory, such as main memory 206. Transmission media includes coaxial cables, copper wire and fiber optics, including the wires that comprise bus 202. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 204 for execution. For example, the instructions may initially be carried on a magnetic disk of a remote computer. The remote computer can load the instructions into its dynamic memory and send the instructions over a telephone line using a modem. A modem local to computer system 200 can receive the data on the telephone line and use an infra-red transmitter to convert the data to an infra-red signal. An infra-red detector can receive the data carried in the infra-red signal and appropriate circuitry can place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic or optical signals that carry digital data streams representing various types of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the world wide packet data communication network now commonly referred to as the “Internet” 228. Local network 222 and Internet 228 both use electrical, electromagnetic or optical signals that carry digital data streams. The signals through the various networks and the signals on network link 220 and through communication interface 218, which carry the digital data to and from computer system 200, are exemplary forms of carrier waves transporting the information.

Computer system 200 can send messages and receive data, including program code, through the network(s), network link 220 and communication interface 218. In the Internet example, a server 230 might transmit a requested code for an application program through Internet 228, ISP 226, local network 222 and communication interface 218.

The received code may be executed by processor 204 as it is received, and/or stored in storage device 210, or other non-volatile storage for later execution. In this manner, computer system 200 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of communicating with other users through an instant messaging application, wherein the instant messaging application includes a plurality of status options, the method comprising:
receiving input from a user of the instant messaging application, wherein the input indicates the selection of a particular status option from the plurality of status options; and
in response to receiving the input, providing, to the user, a plurality of references, wherein each reference of the plurality of references indicates a different user (a) that is using a different instance of the instant messaging application and (b) that has selected the particular status option,
wherein one or more of the references in the plurality of references indicate one or more users that have not previously established, through the instant messaging application, a relationship with the user.

2. The method of claim 1, wherein the instant messaging application is one of a client-based application or a web-based application.

3. The method of claim 1, wherein one or more other references in the plurality of references indicate one or more other users that have previously established, through the instant messaging application, a relationship with the user.

4. The method of claim 1, wherein each reference of a subset of the plurality of references indicates a distinct user that is a member of a social network in which the user is a member.

5. The method of claim 1, wherein:
providing the plurality of references includes selecting the plurality of references from a larger plurality of references.

6. The method of claim 5, wherein:
selecting the plurality of references from the larger plurality of references includes comparing first information with second information;
the first information is information about the user; and
the second information is information about the user associated with each reference of the larger plurality of references.

7. The method of claim 6, wherein:
one or more of the first information and the second information includes profile information.

8. The method of claim 6, wherein:
one or more of the first information and the second information includes web history.

9. The method of claim 1, wherein the plurality of references are a first plurality of references, the method further comprising:
receiving second input from the user; and
in response to receiving the second input, providing, to the user, a second plurality of references, wherein the second plurality of references are references of the same type as the first plurality of references, wherein the second plurality of references is different than the first plurality of references.

10. The method of claim 1, further comprising:
receiving, from the user, second input that indicates that the user wants to communicate with a particular user, wherein the particular user is associated with a reference of the plurality of references; and
generating a window in response to receiving the second input;
receiving, within the window, third input from the user;
sending the third input to the particular user; and
after sending the third input, receiving a message from the particular user.

11. The method of claim 1, further comprising:
receiving, from the user, second input that indicates that the user wants to add the particular user to a contact list of the user, wherein the particular user is associated with a reference of the plurality of references; and
in response to receiving the second input, sending a message to the particular user, wherein the message indicates to the particular user that the user wants to add the particular user to the contact list; and
if the particular user accepts the invitation, adding the particular user to the contact list.

12. A method of communicating with other users through an instant messaging application, the method comprising:
receiving input from a user of the instant messaging application, wherein the instant messaging application is associated with a particular status of a plurality of possible statuses, wherein the input indicates a particular topic about which the user intends to communicate with another user;
in response to receiving the input, comparing the particular topic to a plurality of topics, wherein each topic of the plurality of topics is associated with a separate user of a plurality of users, wherein each user of the plurality of users is associated with the particular status;
providing, to the user, a plurality of references, wherein each reference of the plurality of references indicates a different user (a) that is using a different instance of the instant messaging application, (b) that has selected the particular status, and (c) that indicated a topic that is similar to the particular topic.

13. The method of claim 12, further comprising, before receiving the input from the user:
providing, to the user, a particular set of references, wherein each reference of the particular set indicates a distinct user (a) that is using a different instance of the instant messaging application and (b) that has selected the particular status;
wherein the particular set of references is a different set of references than the plurality of references.

14. The method of claim 13, wherein providing the particular set of references is performed regardless of any topics associated with each distinct user indicated by a reference of the particular set.

15. A method for searching for one or more users, the method comprising:
receiving search criteria from a user of an instant messaging application, wherein the search criteria indicates a status;
in response to receiving the search criteria, identifying a plurality of other users that are associated with the same status, wherein each user of the plurality of other users set their respective status; and
providing, to the user, a plurality of references, wherein each reference of the plurality of references corresponds to a different user of the plurality of other users.

16. A machine-readable storage medium carrying one or more sequences of instructions which, when executed by one or more processors, causes the one or more processors to perform the method recited in claim 1.

17. A machine-readable storage medium carrying one or more sequences of instructions which, when executed by one or more processors, causes the one or more processors to perform the method recited in claim 2.

18. A machine-readable storage medium carrying one or more sequences of instructions which, when executed by one or more processors, causes the one or more processors to perform the method recited in claim 3.

19. A machine-readable storage medium carrying one or more sequences of instructions which, when executed by one or more processors, causes the one or more processors to perform the method recited in claim 4.

20. A machine-readable storage medium carrying one or more sequences of instructions which, when executed by one or more processors, causes the one or more processors to perform the method recited in claim 5.

21. A machine-readable storage medium carrying one or more sequences of instructions which, when executed by one or more processors, causes the one or more processors to perform the method recited in claim 6.

22. A machine-readable storage medium carrying one or more sequences of instructions which, when executed by one or more processors, causes the one or more processors to perform the method recited in claim 7.

23. A machine-readable storage medium carrying one or more sequences of instructions which, when executed by one or more processors, causes the one or more processors to perform the method recited in claim 8.

24. A machine-readable storage medium carrying one or more sequences of instructions which, when executed by one or more processors, causes the one or more processors to perform the method recited in claim 9.

25. A machine-readable storage medium carrying one or more sequences of instructions which, when executed by one or more processors, causes the one or more processors to perform the method recited in claim 10.

26. A machine-readable storage medium carrying one or more sequences of instructions which, when executed by one or more processors, causes the one or more processors to perform the method recited in claim 11.

27. A machine-readable storage medium carrying one or more sequences of instructions which, when executed by one or more processors, causes the one or more processors to perform the method recited in claim 12.

28. A machine-readable storage medium carrying one or more sequences of instructions which, when executed by one or more processors, causes the one or more processors to perform the method recited in claim 13.

29. A machine-readable storage medium carrying one or more sequences of instructions which, when executed by one or more processors, causes the one or more processors to perform the method recited in claim 14.

30. A machine-readable storage medium carrying one or more sequences of instructions which, when executed by one or more processors, causes the one or more processors to perform the method recited in claim 15.
